(19) United States
(12) Patent Application Publication
(10) Pub. No.: US 2008/0129598 A1
(43) Pub. Date: Jun. 5, 2008

(54) Positioning Method and Device

(76) Inventors: Baptiste Godefroy, Lezat/Leze (FR); Christian Carle, Seich (FR)

Correspondence Address: HAYES SOLOWAY P.C., 3450 E. SUNRISE DRIVE, SUITE 140, TUCSON, AZ, 85718, US

(21) Appl. No.: 11/813,198

(22) PCT Filed: Jan. 11, 2006
(86) PCT No.: PCT/FR06/50013

§ 371 Date: Jun. 29, 2007

(30) Foreign Application Priority Data
Jan. 11, 2005 (FR) 0500251

(51) Int. Cl. G01S 1/00; G01S 5/02

(52) U.S. Cl. 342/450

(57) ABSTRACT

The method of positioning a radionavigation signal receiver comprises:
a prediction step to predict reception characteristics of signals emitted by radionavigation signal sources for a plurality of land positions and time values, as a function of the positions of said sources, electromagnetic waves propagation models and topographic knowledge about the environment of each said position;
a receiving step in which said receiver receives radionavigation signals;
a measuring step in which reception characteristics of signals received by said receiver are measured, and
a processing step to process the real measured characteristics and predicted characteristics to provide information related to positioning of said receiver.

This invention relates to a positioning method and device. In particular, it is designed to improve the performances of a satellite navigation system by making use of knowledge of satellite constellations and the environment of a navigation receiver. The invention can improve navigation performances in environments for which these performances are severely degraded by phenomena including propagation of unwanted or masked waves.

Satellite navigation systems are capable of positioning a receiver in three dimensions (x, y, z) anywhere in the world, due to measuring the propagation times of waves emitted by a set of satellites in constellations. However, these systems only operate partially in difficult environments such as urban zones or inside buildings. The calculation of the position based on an assumption about the line of sight propagation of electromagnetic signals between emitting satellites and receivers, becomes impossible when the signals are blocked or attenuated excessively by the environment around the receiver. This calculation can also cause large errors due to signal reflections on obstacles surrounding the navigation receiver.

Different satellite navigation positioning systems are known.

These satellite positioning systems operate only partially in difficult environments such as urban zones or inside buildings. Calculation of the position based on an assumption that electromagnetic signals emitted by satellites are propagated along a line of sight, is made impossible when signals are reflected, blocked or excessively attenuated by elements surrounding the receiver (for example buildings or mountains when the user is outdoors, or the configuration of a building inside which the user is located).

Document WO 01/86315 describes a method and device for determining the location of a mobile unit using satellite signals, in cooperation with a positioning calculation centre that makes use of a geographic information system to simulate possible reception signals, including the power of the signal and delayed or reflected signals. The method also uses signals from a cellular communication system with which the mobile receiver is also associated, in addition to the satellite data and to communicate with the position calculation centre. The method compares the real reception and the simulated model, to improve the approximation of the position of the mobile unit.

This method requires a large amount of real time processing in the calculation centre, and in practice its response time is prohibitive.

This invention is designed to overcome these disadvantages.

More generally, the disadvantages that this invention overcomes concern availability and precision problems of satellite navigation systems, in restrictive environments (urban zone, mountain).

According to a first aspect, this invention relates to a method of positioning a radionavigation signal receiver, characterised in that it comprises:
a prediction step for a set of land positions, to predict reception characteristics of signals emitted by radionavigation signal sources as a function of the positions of said sources, models for propagation of electromagnetic waves and topographic knowledge about the environment of each said position;
a step in which said receiver receives radionavigation signals;
a step in which reception characteristics of signals received by said receiver are measured, and
a step to process the real measured characteristics and predicted characteristics to provide information related to positioning of said receiver.

Due to these measures, the processing duration and the processing resources used in the computer system are very limited. Use of this invention provides the means of avoiding error sources and increasing the coverage of the positioning or navigation service, even when there are not enough satellite signals to determine the position of the receiver in a conventional manner: the invention provides a means of taking account of deteriorated signals or missing signals.

According to particular characteristics, the processing step includes a step in which real measured characteristics are matched with predicted characteristics to supply at least one possible position of said receiver.

Due to these arrangements, the processing is done quickly and it makes positioning possible because matching consists of making measured real values and predicted values correspond, possibly including a step to interpolate between some possible positions and/or to eliminate them.

According to particular characteristics, when predictions of several positions have similar matching degrees during the processing step, the displacement of the receiver and at least two of its successive positions are extrapolated to select one of the possible positions.

With these arrangements, the processing done takes account of the successive positions of the receiver and increases the reliability of positioning.

According to particular characteristics, the method as described briefly above comprises a step to determine the approximate position by said receiver, starting from the received radionavigation signals and during the processing step, the information related to positioning comprises correction information to be applied to the approximate position determined by said receiver.

With these arrangements, the receiver determines its position precisely in two steps.

According to particular characteristics, the method as briefly described above comprises a step to determine the approximate position by said receiver, starting from received radionavigation signals, and during the processing step, the information related to positioning comprises a correction information to be applied to each measurement of the distance to a radionavigation source to correct the approximate position determined by said receiver.

With these arrangements, the determination of the position is more precise.

According to particular characteristics, the method as briefly described above comprises a step in which said receiver determines the approximate position, starting from received radionavigation signals and during the processing step, the information related to positioning comprises information about the integrity of the approximate position determined by said receiver.

With these arrangements, the user can take account of the integrity of positioning.

According to particular characteristics, the method as briefly described above comprises a step in which said receiver determines the approximate position starting from received radionavigation signals, and during the processing step, the information related to positioning comprises integrity information about each measurement of the distance to a radionavigation source to correct the approximate position determined by said receiver, so that the receiver does not take account of at least one of the received radionavigation signals and/or to weight the influence of each distance measurement in the determination of its position.

With these arrangements, the receiver's position can be determined quickly, precisely and completely.

According to particular characteristics, the method as briefly described above comprises a step in which said receiver determines the approximate position starting from the received radionavigation signals, and during the prediction step, the land positions of the plurality of land positions are chosen around said approximate position or around a previous position determined by the processing step.

With these arrangements, the number of land positions to be taken into account is reduced.

According to particular characteristics, a database comprises information regarding positions and predicted reception characteristics of these positions, to represent a time period during which the predicted characteristics are considered to be valid and the processing step uses said database.

With these arrangements, the matching step is performed with predicted characteristics that correspond to the actual satellite position during the time period.

According to particular characteristics, the different characteristics are processed one after the other in the processing step until at least one of the characteristics used can provide position information to the receiver.

With these arrangements, the consumption of resources is optimised. Preferably, the first step is to process characteristics that require the fewest processing resources.

According to particular characteristics, said reception characteristics comprise the received power of signals received by the receiver.

According to particular characteristics, said reception characteristics comprise a set of values characteristic of the correlation functions of the received radionavigation signals.

According to particular characteristics, said reception characteristics comprise polarization of signal received by the receiver.

According to particular characteristics, said reception characteristics comprise the frequency shift of signals received by the receiver.

With each of these arrangements, the position can be determined more precisely and available in constrained environments, in other words in areas in which the coverage of radionavigation signals is not sufficient to determine the position using conventional methods.

According to particular characteristics, at least one of said reception characteristics is used during the processing step to determine the visibility state of each radionavigation source, and this visibility state is used to determine the information related to positioning.

With these arrangements, the processing is done quickly.

According to particular characteristics, during the processing step, the speed and the movement direction of the receiver are determined.

Due to these characteristics, the speed and direction information of the receiver may be provided to the receiver or it may be used for a subsequent prediction step.

According to a second aspect, this invention relates to a device for positioning a radionavigation signals receiver, characterised in that it comprises:
a means of predicting reception characteristics of signals emitted by radionavigation signal sources for a plurality of land positions, as a function of the positions of said sources, electromagnetic wave propagation models and topographic knowledge about the environment of each said position;
a means of storage in a database;
a means of receiving the radionavigation signals by said receiver;
a means of measuring the reception characteristics of signals received by said receiver, and
a means of processing real measured characteristics and predicted characteristics to provide information about the position of said receiver.

The advantages, purposes and characteristics of this device are similar to the advantages, purposes and characteristics of the method as described briefly above, consequently they are not repeated here.

Other advantages, purposes and characteristics of this invention will become clear after reading the following description given for explanatory purposes and in no way limitative, with regard to the appended drawings in which:

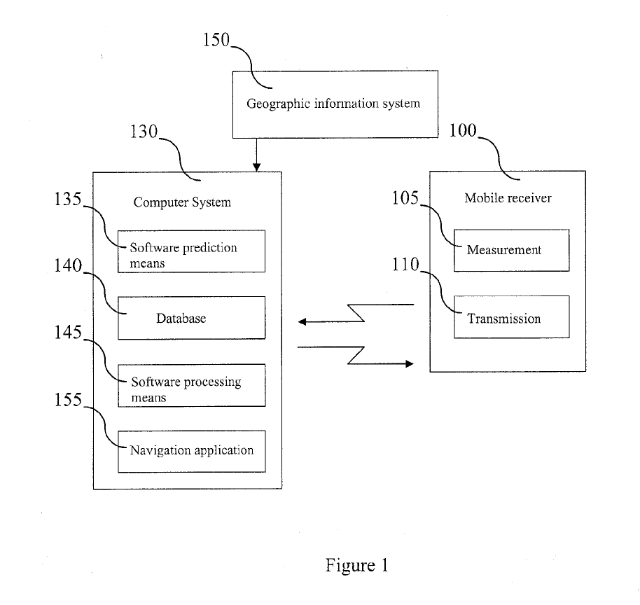

FIG. 1 diagrammatically shows elements used in a particular embodiment of this invention;

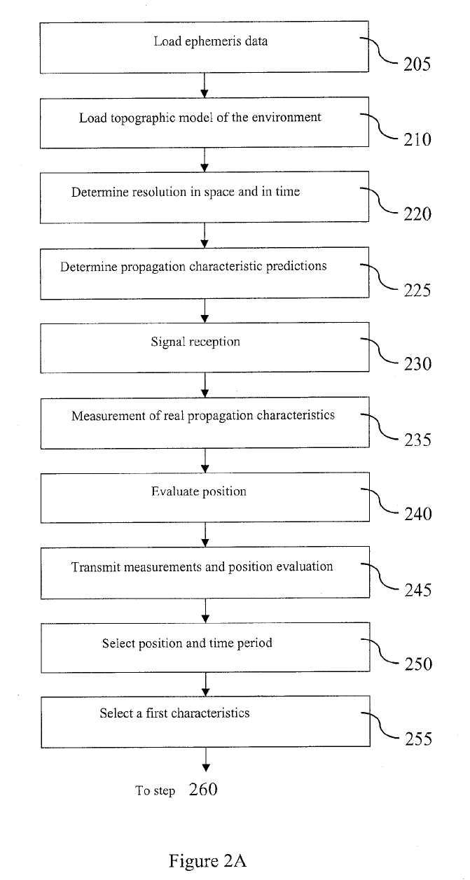

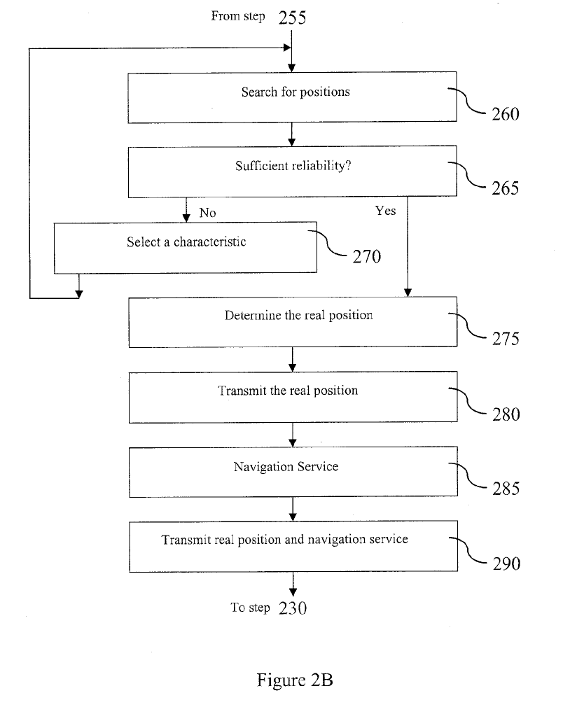

FIGS. 2A and 2B show a logic diagram of the steps used by the different elements illustrated in FIG. 1, in a first particular embodiment of the method according to this invention;

FIG. 3A shows a logic diagram of the steps used by the different elements illustrated in FIG. 1 in a second particular embodiment of the method according to this invention, and

FIG. 3B shows a logic diagram of the steps used by the different elements illustrated in FIG. 1 in a third particular embodiment of the method according to this invention,

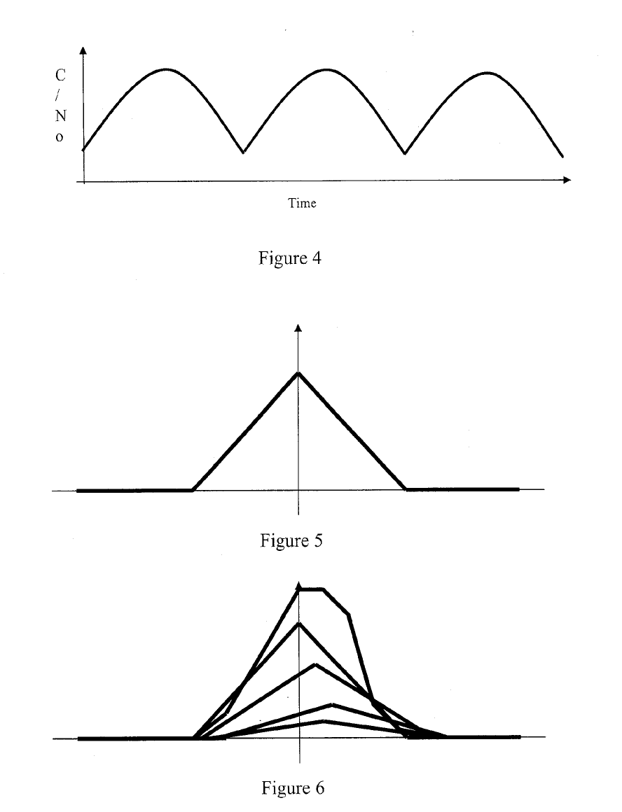

FIG. 4 shows an example of the variation with time of a power of signals received when a navigation receiver picks up the signals both directly and also reflected on a fixed reflector;

FIG. 5 diagrammatically shows a conventional form of a correlation function for a direct path of electromagnetic rays originating from navigation satellites;

FIG. 6 diagrammatically shows a resultant correlation function that takes account of the influence of all rays originating from a particular satellite and having followed different paths (multi-paths) and

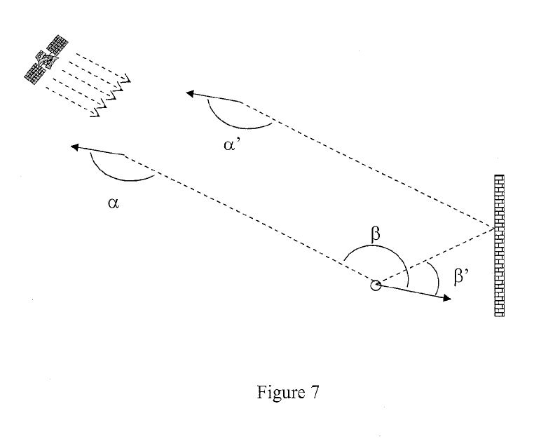

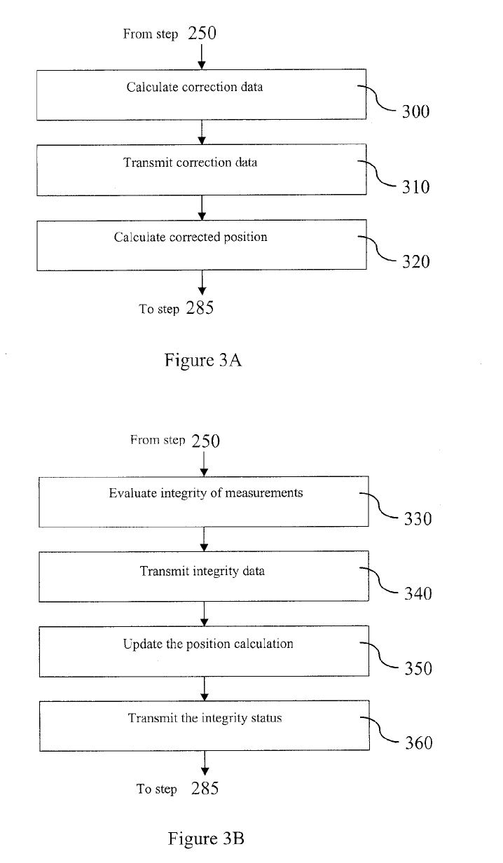

FIG. 7 shows the influence of a reflection on a Doppler effect.

The invention relates to devices and methods for improving the performances of radionavigation systems, for example satellite systems, by knowledge of the environment of the navigation receiver and by modelling propagation of signals from satellites in this environment. The environment of the receiver described in this patent includes natural environments, urban environments and inside buildings.

The method can similarly be applied to GNSS (Global Navigation Satellite System) satellites and their complements, called local or global, or complementary sources to the navigation system (supplementary radiofrequency sources on the ground or in aircraft).

Any source emitting radiofrequency signals and enabling an estimate of the distance or direction to the source by measuring these signals, is considered in this invention as being a complementary source of the navigation system.

The improvement of navigation performances is made by prediction of characteristic values of electromagnetic propagation specific to the environment of one or several users, then by processing of predictions and measurements made by the user of these same characteristics to obtain information related to the user's positioning, for example his position, a correction to be applied to an estimate of his position and/or an evaluation of the integrity of his estimated position and/or the integrity of each signal received by the user.

The term “prediction” is used herein to describe the method that consists of precalculating parameters of interest and recording them in a database. Said prediction is made using a software means incorporating a model of the propagation of electromagnetic waves in the useful environment. Said software means calculate the position of satellites or its complementary sources and propagation of waves from their emission source as far as the navigation satellite, taking account of the environment to be considered.

The position or other navigation information is deduced from the electromagnetic characteristics firstly predicted by the software means, and secondly measured by the navigation receiver, using space-time processing algorithms.

FIG. 1 shows an overview of the elements and methods involved according to the invention. FIG. 1 shows a receiver 100, a computer system 130 and a geographic information system 150.

The navigation receiver 100 comprises means of receiving radionavigation signals and measuring the characteristics 105 of these signals, as is done by satellite navigation receivers. Received signal reception characteristics are measured from signals originating from satellites in the navigation system and possibly its complementary sources. The receiver 100 also has means 110 of transmitting measured parameters, characteristics of the propagation of signals for at least one of the sources of the navigation system to the computer system 130.

As a variant, particular information is determined as a function of measurements made by the computer system 130 (for example by a database and software processing means described later).

The computer system 130 comprises software prediction means (we also have software prediction means 135, a database 140, software processing means 145 and a navigation application 155.

The software prediction means 135 predict values of reception characteristics for a plurality of land positions. These predicted values are memorised in the database 140. The software processing means 145 process real measurements made by the receiver and predicted measurements to provide information related to the position of the receiver 100, to this receiver and/or to the navigation application 155.

Methods related to the measurement of reception characteristics are described below as an example and by way of explanation, without reducing the application field of the invention to these methods.

The position of the receiver 100 may be one of the reception characteristics used by the computer system 130. Similarly, the remote estimate of each of the sources of the navigation signals may be one of the reception characteristics used by the computer system 130.

Another reception characteristic, the received power of signals from a satellite, may be determined by measuring the electrical energy passing through channels in phase (I) and in phase quadrature (Q) from the navigation receiver 100, and corrected to the observation time of this energy. In general, reference is made to a measurement of the signal to noise density ratio C/No when the energy is measured on the input and output side of correlators and in different filter bands. This received power measurement is usually made by known navigation receivers so as to monitor acquisition or tracking of each satellite signal. In some known types of receivers, the received power deduced from this signal to noise density ratio may be used to weight the influence of each pseudo-distance measurement between the receiver and a satellite, in the positioning algorithm.

In applying this invention, the measurement results concern propagation or reception characteristics that may be predicted as a function of the knowledge of the receiver environment and modelling of propagation phenomena in this environment. The power received on each receiver channel (for each satellite or navigation source) is in particular characteristic of the propagation of waves from the source to the receiver. As variants, threshold values are used to represent propagation characteristics. For example, a threshold value is used to determine if the signals received from a source of navigation signals are received directly (in line of sight) or after a particular propagation phenomenon (reflection, propagation through a material, diffraction). Reception of signals from satellites in line of sight is particularly relevant in the context of this invention. This concept may be used by software processing means as a first characteristic element of propagation, due to its simplicity of use both in measurement means and in the software means of a computer system (see below).

The variation in the power measurement received from a signal originating from a satellite is also used. When the propagation channel involves reflections or diffractions, a periodic variation of the measured power is observed, and this variation may be both in time and in space. Therefore, measurement of this variation gives information about propagation of signals, and in particular may be used to determine the presence of reflected paths disturbing the navigation measurement.

FIG. 4 shows an example variation of the power as a function of time when the navigation receiver picks up a satellite directly but also by reflection on a fixed reflector. The measurement of the variation amplitude and/or the shape of the spatial or time variation, are characteristics that can be supplied by the measurement means 105.

Distance measurements made in a satellite navigation system are based on synchronization of the navigation code sent by each satellite with a reply generated by the receiver. In particular, the time correlation principle and a code discriminator are used to measure a code phase shift, and this measurement is used in tracking loops that synchronise the code with its reply. This method is usually described using a correlation function.

FIG. 5 clarifies the conventional shape of this correlation function (in the conventional case in which the C/A code of a GPS type satellite is used). The error induced by multi-path phenomena can be predicted by studying the deformation of the correlation function. Each ray originating from a satellite accepts a delay and a characteristic power of the propagation phenomena applied to it. The resultant correlation function can then be plotted, taking account of the influence of all rays originating from the same satellite and that followed a different path. FIG. 6 shows an example of a characteristic multi-path correlation function (the top curve is the resultant of characteristic correlation functions of each ray). The deformation of the correlation function due to the influence of signals with a delay and an attenuation or gain compared with the direct path, can be observed.

The measurement means 105 measure the value of this correlation function at a few points, or in the case of so-called <multi-correlator >> receivers or receivers using an acquisition principle based on FFT (Fast Fourier Transform), the correlation function as a whole is plotted. The shape of this correlation function is largely related to propagation phenomena, which is why this measurement is particularly suitable for this invention, enabling a relevant comparison of the measurement with predictions.

Polarisation of waves is also a propagation characteristic. Waves in conventional navigation systems are emitted by satellites in right circular polarisation. Therefore a ray received directly have this polarization state, while a wave that has been reflected or transmitted or diffracted will have a different polarization, right or left elliptical. The measurement means 105 use methods for measuring the state of polarization described in prior art and based on the use of several antennas accepting different polarizations, usually circular right and left, or two antennas in linear polarisation but oriented differently.

The frequency shift (“Doppler” effect) of each satellite depends on the relative velocity of the satellite and the receiver on the satellite-receiver axis. The Doppler shift can be broken down into two terms:

DopplerTotal=DopplerReceiver+DopplerSatellite

The first term corresponds to the influence of the displacement of the receiver 100, and the second term to the influence of the displacement of the satellite. Therefore, the measurement of the Doppler shift measured in the receiver by the phase tracking loop, provides an estimate of information about the velocity of the mobile receiver.

However, in an environment characterized by multi-paths, measurement of the receiver Doppler effect is distorted. The Doppler shift of a reflected signal actually corresponds to the relative velocity of the receiver on the propagation axis at the arrival of the signal on the antenna. Therefore, depending on the position of the reflection point, the Doppler measurement can provide distorted information for the calculation of the velocity of the mobile. This principle is illustrated in FIG. 7.

The difference in the Doppler calculation on the line of sight path and on the reflected path can be seen in the typical case of reception of a multi-path shown in FIG. 7. On the direct path, we have:

$$Δ {f}_{d} = \frac{{v}_{sat}}{λ} cos α + \frac{{v}_{mob}}{λ} cos β$$

For the reflected path:

$$Δ {f}_{d}^{′} = \frac{{v}_{sat}}{λ} cos {α}^{′} + \frac{{v}_{mob}}{λ} cos {β}^{′}$$

Thus, the difference in the Doppler shift is related to the speed of the mobile receiver and the angle formed between this speed vector and the direction of incidence of the reflected path, depending on whether the measurement is made on the direct path or on the reflected path.

Characteristic parameters for reception or propagation of electromagnetic signals comprise:
the position of the receiver, estimated by the receiver,
the distance of the receiver to each radionavigation signal source, estimated by the receiver,
the power received from signals or the variation of this power,
the correlation function of navigation codes,
the polarization of electromagnetic waves penetrating the navigation receiver antenna,
the frequency shift or the carrier phase (Doppler effect, propagation effects, etc.) from each signal and/or
any other information characteristic of the propagation of signals

Envisaged satellite navigation receivers non-exhaustively include GPS (registered trademark, Global Positioning System) receivers, receivers incorporating SBAS (Satellite Based Augmentation System) type reception from geostationary satellites, for example the EGNOS (registered trademark, European Geostationary Navigation Overlay Service) system or WAAS (registered trademark, Wide Area Augmentation System), receivers using the GLONASS (registered trademark, GLObal NAvigation Satellite System) navigation system, soon the Galileo navigation system, and also compatible receivers using a combination of these satellite navigation systems or any other present or future satellite navigation system. The navigation receiver can also process navigation signals originating from local augmentation radiofrequency systems or other radionavigation means (use of pseudolites, LOPAN—registered trademark, acronym of Long RAnge Navigation).

A computer system 130 uses software prediction means 135, a database 140 and software processing means 145.

The software prediction means 135 predict the value or the state of a certain number of parameters characteristic of propagation, at least for a given instant and for a plurality of land positions. For example, the positions for which the prediction is made are located on a regular mesh with a square or triangular grid, at a pitch of five meters.

The predicted parameters correspond to the parameters transmitted by the navigation receiver. For example, the second term of the Doppler effect may be predicted by taking account of the trajectory of satellites, using ephemeris data or almanacs broadcast in the navigation message of satellite navigation systems. Therefore the measurement of the Doppler shift of each satellite depends on propagation phenomena and according to this invention, can be used for processing real Doppler measurements and predicted Doppler values. In particular, the measurement can be used to detect reception of a reflected path, relevant information for software processing means 145. The software processing means can also be used to correct an estimate of the speed of the mobile based on Doppler measurements by prediction of the influence of multi-paths as a function of the position and orientation of the reflectors considered.

In general, the prediction made by software prediction means 135 is based on a physical model of electromagnetic wave propagation phenomena like those used by satellite navigation systems. Modelling can use statistical or deterministic models. Among deterministic models, the software prediction means 135 can use models based on the geometric optics theory and diffraction theories (uniform theory of diffraction, physical theory of diffraction). The invention can use any other theory about modelling of the propagation of electromagnetic waves. The computer system 130 is supplied with information from a geographic information system and modelling of the environment to be processed 150, and provides the database 140 with electromagnetic characteristics for reception of predicted satellite signals in the processed environment, for at least one time period and a plurality of land positions.

The term “prediction” herein is used to describe all propagation calculations made by the software prediction means 135. The term “prediction” is used because in accordance with this invention, the propagation calculations are made in advance in the zone of interest of the application (urban area, particular building, etc.) to be stored in the database 140 as a function of future positions of sources of electromagnetic signals. In applying these predictions, this invention solves and satisfies problems related to resources available to do the calculations.

Performing a method for prediction of a reception characteristic from an environment model is a standard method for those skilled in the art. For example, such a method for prediction of the above mentioned C/N ratio is described in the article by Yongcheon suh et al. entitled <<Evaluation of multipath error and signal propagation in complex 3D urban environments for GPS multipath identification>>, published in the report on the ION GNSS 17th International meeting of the satellite division, 21-24 Sep. 2004, pages 1147-1156.

Predictions have a resolution in time, a validity time period chosen such that information recorded in the database 140 can remain valid at each instant at which the processing is done by the software processing means 145. The variation of predictions depends largely on the variation of the position of satellites with respect to the zone in which the mobiles are located. Thus, it is possible to choose a relatively small time resolution for predictions (of the order of a few minutes, in other words the duration of the validity time period), assuming that during this period the predicted information related to propagation of signals originating from satellite has not changed very much. Optimisation of this time resolution of predictions can significantly reduce the calculation resources necessary for the software prediction means 135.

Furthermore, since the satellite movement is cyclic and has approximately the same rotation period around the earth, the same predictions are valid for several successive configuration cycles of the satellite constellation. For example, the cycle is 23h56 for GPS and about 3 days for Galileo. However, this cycle is theoretical and there may be deformations. Thus, the calculation resources necessary for predictions are reduced. However, it is preferable to repeat the predictions as frequently as possible as a function of available resources.

The resolution in space (the distance between two land positions studied) of data contained in the database 140 is chosen as a function of the application and the required positioning precision performances, and the resources available for calculation and storage of these data.

One means of reducing the memory space necessary for data storage is to reduce the number of land positions for which a prediction is made. To give an explanatory example, the principle of the processing algorithm performed by the software processing means 145 could be to determine which of the points in the database 140 are potentially position solutions (points for which correspondence between the predicted characteristics and the real measured characteristics is high). The objective is to reduce the number of possible points to be considered, which also reduces updating of predictions at these points (particularly when the predictions are updated practically in real time as a function of the processing results). This method can reduce calculation resources necessary for the prediction.

The stored predicted information includes all the propagation or reception characteristics of signals useful to the software processing means 145, in other words all or some of the characteristics that are also measured by the navigation receiver 100. Statistical or probabilistic information used to estimate the validity of each pseudo distance measurement or Doppler measurement is also kept in the database, so as to optimise weighting of how they are taken into account by the software processing means 145.

A geographic information system (SIG) 150 provides the software prediction means 135 with a topographic model of the environment for a plurality of land positions. The term “environment” herein includes all physical elements (discontinuities of natural relief or human constructions) located in a zone surrounding the land positions considered. The model of the environment is preferably made using three-dimensional digital models (3D models or possibly 2.5D models), that are particularly well adapted to envisaged propagation models such as models using ray tracing.

The database 140 keeps a set of electromagnetic reception characteristics of satellite signals and characteristics of their complementary sources, for each land position referenced in the database, or a preferred plurality of land positions determined from the previous processing results by software processing means 145, and preferably for a multitude of time periods in the future.

The software processing means 145 use reception or propagation characteristics measured by the receiver and the content of the database 140 to determine at least one possible position of the receiver as a function of a position estimate provided by the receiver, either as a function of the received signals or as a function of the previous receiver positions, or as a function of a combination of the two.

In variants, during the processing step, the software processing means 145 determine the state of visibility of the receiver, in other words the line of sight visibility (with no masking), indirect visibility (the signal from a satellite is received despite being masked), or the absence of a received signal for each satellite in the constellation.

If the receiver is capable of providing an estimate of its position as a function of the electromagnetic signals that it receives, the software processing means only search for possible positions in the database located close to the position estimated by the receiver. The following predictions may possibly be made only at these points, so as to limit calculation resources.

If the receiver is not capable of providing an estimate of its position as a function of the electromagnetic signals that it receives, the receiver provides at least one position previously occupied by this receiver and by interpolation, the processing means determine an estimated position of the receiver and only search for possible positions in the database located close to the position estimated by the receiver. As a variant, the computer system comprises a means of memorizing successive positions of the receiver, to use displacement information in the processing method applied by the software processing means 145. Preferably, these positions are stored in another operating database, and not in the database 140 that then only contains predictions.

The software processing means 145 determine the most probable position as a function of these possible positions, either by interpolation between correlation factors of characteristics at these possible positions and measured characteristics, or by interpolation of positions occupied sequentially by the receiver.

The software processing means 145 may be based on a wide variety of mathematical methods using Bayesian type probabilistic models (Kalman filters, <<Hidden Markov>> models, probability grid, particle filtering, neuron networks, etc.), models based on polynomial interpolation, on the state logic, or on a combination of these methods.

As mentioned, the purpose of the processing step is to obtain the most probable position of the receiver from measured and predicted reception characteristics. To achieve this, the processing step determines the probability that each point corresponds to the real position of the receiver, taking account of a priori information (predicted characteristics stored in the database 140) and the measured characteristics, at several points defining a grid corresponding to possible user positions.

An example implementation of the processing algorithm is given below:

A posteriori probabilities of line of sight (LOS) visibility of different satellites are determined starting from the measured characteristics, for example signal to noise ratios for signals received from these satellites. The result is thus a vector of relative probabilities at the receiver at a given instant, called the a posteriori visibility state. Furthermore, the database 140 provides a priori probability vectors (or a priori visibility states) of different points in the above mentioned grid, either directly or using a previous calculation starting from the predicted characteristics. The differences between the a priori and a posteriori visibility states give the receiver position probabilities at the different points of the grid, in other words a grid of probabilities in which it is easy to extract the most probable position simply by comparison.

In order to reduce the estimation error, it is possible to obtain several probability grids corresponding to different types of state, and then to make the comparison on the resulting grid.

Although the processing algorithm presented above gives the receiver position, in general it can provide navigation information, namely also or instead:
the position of the receiver or a positioning area
the speed of the receiver
the movement direction

This information can then be used to enable a navigation application, or transmitted to the receiver so as to optimise processing of signals specific to the navigation receiver. Receivers perform a number of processing of received satellite signals, for example to synchronise tracking loops on the signal, and this synchronisation is facilitated by knowledge, even approximate, of the receiver position. Therefore the position determined by the processing means is useful information to the navigation receiver, particularly when the navigation receiver does not have sufficient measurements to determine a position independently. Other types of information formatted by the software prediction means, such as the visible or hidden state of a given satellite in a zone surrounding the position of the navigation receiver, may be used to improve processing of signals. Typical receivers permanently do a time frequency search for signals originating from satellites that were not previously tracked. A priori knowledge supplied by the processing step in this invention about non-availability of signals originating from a given satellite (at sufficient power levels) in a zone surrounding the receiver, provide a means of concentrating calculation resources on other potentially receivable satellites, thus improving the acquisition time of these satellites and reducing consumption of the navigation receiver.

As a variant, when the application uses several independent navigation systems, the software processing means can use these predictions to determine the performance level associated with each navigation system. They can then provide the navigation receiver with this qualitative information, to control the signal processing strategy in the navigation receiver. For example, if one of the systems considered is a satellite system such as GPS, and the receiver can use another positioning system based on reception of sources based on the ground (for example pseudolites), the software processing means can provide information to the receiver indicating the system giving the best positioning performances as a function of its previously determined position.

In the embodiment described and represented, the navigation software means 155 implement the navigation application. They use navigation information provided by the software processing means 145 and also the database 140 concerning the environment. It is thus capable of representing the position of each user of a device according to this invention in its environment in three dimensions, for example on a screen (not shown) of the navigation receiver 100.

The software processing means 145 are based on a comparison of the predicted characteristics kept in the database 140 with propagation or reception characteristics measured by the navigation receiver. The purpose of the software processing means 145 is to provide a plurality of possible positions, or ideally the most probable position, for each mobile receiver 100 using this invention.

The processing done by the software processing means 145 applies to a number of information items characteristic of the reception of signals from satellites. This information is stored in a state vector. Each state parameter considered is determined from measured characteristics.

The characteristics describing the state vector are given satellite by satellite and in particular contain: direct visibility, visibility after reflection, the signal to noise ratio, the correlation function, pseudo-distance measurements, Doppler measurements and the polarisation analysis.

Several measurement instants can be used by the processing algorithm applied by the software processing means 145 so as to evaluate the variation with time of each parameter. For example, a significant modification of a measured characteristic from one measurement instant to another is information useful for processing (for example loss or acquisition of a satellite).

Direct or indirect visibility may be determined from one or several items of information measured by the navigation receiver. It can be estimated by measuring the signal to noise ratio or the variation of this ratio from polarization of received wave, or by studying the value of the measured Doppler shift and the variation of this shift with time. Furthermore, the presence of a multi-path degrading the measurement of the direct path may be detected by observation of the correlation function.

Visibility parameters are very important for the software processing means 145. They can significantly reduce the space of possible positions, to minimise calculation costs. According to the invention, a hierarchised design of the processing can optimise the information to be compared. One example of the hierarchised operating organization of the software processing means 145 is given below:
as a first step, the measurements and predictions of the direct and indirect visibility of satellites are used to considerably reduce the zone of possible positioning solutions to include only solutions for which the state of visibility of satellites coincides with predictions. The processing can then be restricted to this zone in which visibility is consistent. Depending on the number of available satellites, the procedure then uses other measurements such as correlation function measurement, power measurement, Doppler shift measurements, and variation of these measurements with time, so as to reduce the processing zone or simply to associate a probabilistic type value with each land position in the processing zone, translating the quality of processing between the measurements and predictions.
pseudo-distance and Doppler type measurements are then used to specify the position in a reduced processing consistency zone. In the processing zone, the probabilistic weight associated with each point can be specified by a measurement of consistency between pseudo-distance measurements, the real distance from these points to satellites, and predicted pseudo-distance measurements (the predictions including an estimate of bias or variance type errors).

According to the invention, information derived from these predictions can actually be applied to different levels in the algorithmic positioning methods:
processing results made by software processing means 145 may be used to reduce the possible solutions space and thus improve navigation performances in terms of precision. (As described above with reference to FIGS. 1 to 7 and below with regard to FIGS. 3A and 3B);
prediction information can be used to correct or weight the use of each pseudo-distance measurement so as to improve the positioning precision. When sufficient radionavigation signals are available, the conventional radionavigation receiver calculates its position using a triangulation method based on distance measurements between the receiver and each satellite. These measurements are called <<pseudo-distances >>. These measurements are deteriorated by propagation phenomena. The receiver can provide these pseudo-distance measurements to the computer system in step 245. According to the second embodiment illustrated in FIG. 3A, the prediction of propagation phenomena provides a means of evaluating the corresponding measurement error for each radionavigation source. The corrections to be applied are then calculated by the computer system in step 300, and transmitted to the navigation receiver in step 310. The receiver takes the corrections into account to correct its estimate of the position in step 320, using differential correction procedures known in the state of the art.
propagation phenomena prediction information can be used to predict large errors in the measurement of pseudo-distances by the receiver. Thus, in the third embodiment illustrated in FIG. 3B, an integrity information for this measurement is determined for each measurement in step 330 as a function of predictions and real characteristic measurements made by the receiver. These integrity data are then transmitted to the receiver in step 340. It is observed that the integrity information transmitted to the receiver can be global for the position determined by the receiver or by a signal originating from each radionavigation signal source. According to known methods in the framework of augmentation systems already mentioned such as WAAS and EGNOS systems, this integrity information of each measurement is used by the receiver, either to choose whether or not to use a measurement in the positioning algorithms in step 350 (if the number of measurements is large and can be used to not consider some of them), or to weight the influence of each measurement in determining the position in step 350 (typical case of triangulation by weighted least square type algorithms) or to transmit the calculated position integrity status to the system user in step 360.

It would also be possible to consider using the precise position obtained by the processing step to reduce the receiver latching time in the case in which satellites are lost: there is a link between the receiver position and the signal acquisition performance (acquisition time). An estimate of the position can be used to optimise receiver processing.

FIG. 2A shows a preliminary step 205, to load satellite ephemeris data into the computer system. Then the topographic model of a plurality of land positions, for example urban and mountain zones, a region in which the method according to this invention is used, is loaded into the computer system from the geographic information system during a preliminary step 210.

Then during a preliminary step 220, the spatial resolution and the resolution in time of the predictions is determined. These resolutions may be different depending on the zone of the region of use: for example, the spatial resolution and the resolution in time are increased in the largest towns and in mountains to take account of a stronger probability of a disturbance of propagation of satellite waves.

Then in a preliminary step 225, the predicted propagation or reception characteristics for each satellite and for each complementary source are determined for each land position and for each time period determined during step 220, as a function of topographic information provided by the geographic information system.

During a step 230, a receiver receives electromagnetic signals from satellites and complementary sources.

During a step 235, the receiver determines the propagation or reception characteristics of signals from each source, satellites and complementary sources.

During a step 240, the receiver evaluates its position as a function of received signals or as a function of its most recent positions, speeds and displacement directions, by interpolation. As a variant, the computer system makes this interpolation.

During a step 245, the receiver transmits the evaluation of its position and propagation and reception characteristics of the received signals, to the computer system.

During a step 250, the computer system makes a selection of land positions of the database and the time period to be examined. The land positions to be examined are the land positions close to the position evaluated by the receiver.

During a step 255, the computer system selects a first characteristic of the transmission or propagation to be examined.

The characteristics involved, source by source, include particularly direct visibility, the visibility after reflection, the signal to noise ratio, the correlation function, pseudo-range measurements, Doppler measurements and the polarization analysis.

The first step is to use measurements and predictions of the direct and indirect visibility of satellites, so as to considerably reduce the zone of possible positioning solutions to include only position solutions for which the state of visibility of satellites coincides with predictions. The next step is to use other characteristics, to measure the correlation function, power measurement, Doppler shift measurements and the variation of these measurements with time.

Pseudo-distance and Doppler type measurements are then used to clarify the positioning of the receiver in a reduced consistency zone of the processing done by the software processing means 145. The probabilistic weight associated with each point in a consistency zone can be clarified by a consistency measurement between the pseudo-distance measurements, the real distance from these points to the satellites, and the predicted pseudo-distance measurements.

It is observed that the order in which measurements or characteristics as described above, is given only as an explanatory example.

During a step 260 (FIG. 2B), the computer system makes a search among the selected land positions and for the selected time period, for land positions for which a value of the characteristic to be examined is close to the value measured for the receiver.

During a step 265, the computer system determines if the reliability of land positions determined during step 255 is greater than a threshold value.

If it is, the computer system goes to step 275. Otherwise, during a step 270, the computer system selects a new propagation or reception characteristic to be examined, in the order indicated in step 255, and returns to step 260.

During step 275, the computer system determines the real position of the receiver, its speed and the direction of its movement as a function of:
possible positions determined during the step 260;
recent positions of the receiver;
differences between values of the characteristic examined for the possible points and the value for this characteristic determined by the receiver.

Depending on possible positions, the software processing means 145 determine a single probable position, either by interpolation between characteristic correlation factors at these possible positions and the measured characteristics, or by interpolation of positions occupied successively by the receiver, taking account of its speed and the direction of its movement.

Then, during a step 280, the computer system transmits the real position of the receiver, and its speed and the direction of its movement to a navigation application.

During a step 285, the navigation application uses the real position of the receiver, its speed and the direction of its movement, to provide a navigation service in a known manner.

During a step 290, the navigation application provides the real position, the speed, the movement direction and the navigation service to the user of the receiver. The receiver returns to step 230 after a predetermined period.

It is observed that this invention may be implemented by several physical architectures, the target application affecting the choice of architecture. Two fundamentally different solutions are conventionally used for navigation applications. Their fundamental difference is in the physical positioning of the means of calculating the navigation solution. The two fundamentally different solutions are usually centralized type architectures (user positions calculated by a calculation centre) with distributed type architectures (position calculated by each user).

According to the invention, two main types of architectures can be envisaged:
for central use, the mobile user only has a mobile navigation receiver and a means of communicating to an application server. It provides its measurements to a server containing software prediction means, the geographic information system, the database and software processing means 145. Therefore, the predicted navigation information is stored on a server. Depending on the application, this information may be transmitted to the user or to an application management server.
for distributed type use, the mobile user has the navigation receiver and calculation resources necessary for operation of the software processing means 145 and software prediction means 135. Depending on the envisaged application, the user also has a communication means for transmission of his navigation solutions and for downloading information from the geographic information system. He can also use the geographic information system on internal memory resources, and then does not require any communication link with the outside. In this case, he performs a so-called standalone navigation.

A hybrid type architecture could also be envisaged, in other words with partial distribution in which the receiver comprises means of receiving the predicted reception characteristics and software processing means 145, the radionavigation assistance server then comprising software prediction means 130, the database 140 and possibly the geographic information system 150. The server then provides the predicted reception characteristics on request from the client user, and the client user handles the processing to obtain positioning information.

It can be seen that as a variant, the prediction database can keep drift information in time to be used to determine the predicted value as a function of the precise time and a reference time in each validity time period of the predictions kept in the database.

As a variant, the software processing means interpolate between the predicted characteristic values for at least two time periods to determine the predicted characteristics corresponding to a precise time.

1. Method of positioning a radionavigation signals receiver, characterised in that it comprises:
a prediction step to predict reception characteristics of signals emitted by radionavigation signal sources for a plurality of land positions, as a function of the positions of said sources, electromagnetic wave propagation models and topographic knowledge about the environment of each said land position;
a receiving step in which said receiver receives radionavigation signals;
a measuring step in which reception characteristics of signals received by said receiver are measured, and
a processing step to process real measured characteristics and predicted characteristics to provide information related to positioning of said receiver.

2. Method according to claim 1, characterised in that the processing step includes a step in which real measured characteristics are matched with predicted characteristics to supply at least one possible position of said receiver.

3. Method according to claim 2, characterised in that, when predictions of several positions have similar matching degrees during the processing step, the displacement of the receiver and at least two of its successive positions are extrapolated to select one of the possible positions.

4. Method according to claim 1, characterised in that the method comprises a step to determine the approximate position by said receiver, starting from received radionavigation signals and in that during the processing step, the information related to positioning comprises correction information to be applied to the approximate position determined by said receiver.

5. Method according to claim 1, characterised in that the method comprises a step to determine the approximate position by said receiver, starting from received radionavigation signals and in that during the processing step, the information related to positioning comprises a correction information to be applied to each measurement of the distance to a radionavigation source to correct the approximate position determined by said receiver.

6. Method according to claim 1, characterised in that the method comprises a step in which said receiver determines the approximate position, starting from received radionavigation signals and in that during the processing step, the information related to positioning comprises information about the integrity of the approximate position determined by said receiver.

7. Method according to claim 1, characterised in that the method comprises a step in which said receiver determines the approximate position, starting from received radionavigation signals and in that during the processing step, the information related to positioning comprises integrity information about each measurement of the distance to a radionavigation source to correct the approximate position determined by said receiver, so that the receiver does not take account of at least one of the received radionavigation signals and/or to weight the influence of each distance measurement in the determination of its position.

8. Method according to claim 1, characterised in that the method comprises a step in which said receiver determines the approximate position starting from the received radionavigation signals and in that during the prediction step, the land positions among the plurality of land positions are chosen around said approximate position or around a previous position determined by the processing step.

9. Method according to claim 1, characterised in that a database comprises information regarding positions and predicted reception characteristics of these positions, to represent a time period during which the predicted characteristics are considered to be valid and the processing step uses said database.

10. Method according to claim 1, characterised in that the different characteristics are processed one after the other in the processing step until at least one of the characteristics used can provide position information to the receiver.

11. Method according to claim 1, characterised in that said reception characteristics comprise the received power of signals received by the receiver.

12. Method according to claim 1, characterised in that said reception characteristics comprise a set of values characteristic of the correlation functions of the received radionavigation signals.

13. Method according to claim 1, characterised in that said reception characteristics comprise polarization of signal received by the receiver.

14. Method according to claim 1, characterised in that said reception characteristics comprise the frequency shift of signals received by the receiver.

15. Method according to claim 1, characterised in that at least one of said reception characteristics is used during the processing step to determine the visibility state of each radionavigation source, and this visibility state is used to determine the information related to positioning.

16. Method according to claim 1, characterised in that during the processing step, the speed and the movement direction of the receiver are determined.

17. Device for positioning a radionavigation signals receiver, characterised in that it comprises:
computer readable program code for predicting reception characteristics of signals emitted by radionavigation signal sources for a plurality of land positions, as a function of the positions of said sources, electromagnetic wave propagation models and topographic knowledge about the environment of each said position;
information storage medium for storing said predicted characteristics in a database;
a signal receiving device for receiving the radionavigation signals by said receiver;
a signal measuring device for measuring the reception characteristics of signals received by said receiver, and
a processor including computer program code for processing real measured characteristics and predicted characteristics to provide information about the position of said receiver.

18. Radionavigation receiver, characterised in that it comprises:
a signal measuring device for measuring the reception characteristics of signals received by said receiver
a signal receiving device for receiving the reception characteristics of signals emitted by radionavigation source, predicted for a plurality of land positions, as a function of positions of said sources, electromagnetic wave propagation models and topographic knowledge of the environment of each said land position;
a processor including computer program code for processing measured characteristics and predicted characteristics to provide information about the position of said receiver.

19. Radionavigation assistance server, characterised in that it comprises:
computer readable program code for predicting reception characteristics of signals emitted by radionavigation signal sources, for a plurality of land positions, as a function of the positions of said sources, electromagnetic propagation model and topographic knowledge of the environment of each said land position;
information storage medium for storing of said predicted characteristics in a database;
a processor including computer readable program code for providing said predicted reception characteristics for said land positions on request from a user.
